(19) United States
(12) Patent Application Publication
(10) Pub. No.: US 2016/0190584 A1
(43) Pub. Date: Jun. 30, 2016

(54) LI-ION BATTERY POSITIVE ELECTRODE MATERIAL, METHOD PREPARING THE SAME AND APPLICATION THEREOF

(71) Applicant: Qinghai Contemporary Amperex Technology Limited, Xining City (CN)

(72) Inventor: Guan WU, Xining City (CN)

(73) Assignee: Qinghai Contemporary Amperex Technology Limited, Xining City (CN)

(21) Appl. No.: 14/973,599

(22) Filed: Dec. 17, 2015

(30) Foreign Application Priority Data
Dec. 26, 2014 (CN) 201410829966.6

(51) Int. Cl. H01M 4/58; C01B 25/455; H01M 10/0525; H01M 4/587; H01M 4/36

(52) U.S. Cl. CPC H01M 4/5825; H01M 4/587; H01M 4/366; H01M 10/0525; C01B 25/455; H01M 2004/028

(57) ABSTRACT

The present application discloses a Li-ion battery positive electrode material, a method for preparing the same and application thereof. The positive electrode material can reduce the relative volume change rate of the positive electrode material in insertion and deinsertion states of Li ions, and meanwhile can efficiently restrain Mn in the positive material from dissolving out during charging and discharging cycles, thereby improving the crystal structure stability of the positive electrode in the working state. A Li-ion battery applying such a positive electrode material has excellent cycle performance, safety and high-temperature storage performance.

### TECHNICAL FIELD

The present application relates to a Li-ion battery positive electrode material and method for preparing the same, and belongs to the technical field of Li-ion battery.

### BACKGROUND

With the increase of performance and decrease of costs of Li-ion batteries, the Li-ion batteries have been increasingly applied in markets including consumer electronics, electrical vehicles, energy storage and the like. In a Li-ion battery, the positive electrode material is a key element for the performance of the Li-ion battery, and the development of a positive electrode material with excellent electrochemical performance and safety performance is an important research subject currently in the Li-ion battery field. As a positive electrode material of a Li-ion battery, LiMnₓFe₁₋ₓPO₄ has a higher operating voltage platform and theoretical energy density than LiFePO₄, and meanwhile has many advantages such as high theoretical specific capacity, low costs, environment-friendly and so on. However, the electronic conductivity and ion diffusion rate of LiMnₓFe₁₋ₓPO₄ are lower than those of LiFePO₄, which limits the electrochemical performance of LiMnₓFe₁₋ₓPO₄ electrodes and affects commercial application thereof.

Currently the main method for industrially preparing a LiMnₓFe₁₋ₓPO₄ material is similar to the method for preparing LiFePO₄. Regardless of a solid phase synthesis method or a solution synthesis liquid method, the prepared LiMnₓFe₁₋ₓPO₄ materials all have the defect of poor stability of electrochemical performance.

### SUMMARY OF THE INVENTION

According to one aspect of the present application, a Li-ion battery positive electrode material is provided. This material can reduce the relative volume change rate of the positive electrode material in insertion and deinsertion states of Li ions, and meanwhile can efficiently restrain Mn in the positive material from dissolving out during charging and discharging cycles, thereby improving the crystal structure stability of the positive electrode in the working state.

The Li-ion battery positive electrode material is characterized in comprising a compound having a chemical constitution represented by formula I:

LiMnₓFe₁₋ₓP₁₋ₐSiM_{c}O_{4-d}F_{d} Formula I

in which, M is selected from at least one of As, B, Cl and S; 0.1≦x≦0.9, 0<b≦0.15, 0<c<0.1, 0<d<0.1, a=b+c, and d<2a.

According to the common knowledge in the art, the compound should keep electrically neutral. In the formula I, x, a, b, c and d are set to be within respective value ranges and keep electric neutrality of the compound.

Preferably, the compound having the chemical constitution represented by formula I has an olivine-type crystal structure of an orthorhombic crystal system.

The compound has a crystal structure identical to an olivine-type LiFePO₄ of an orthorhombic crystal system, and is a crystal material obtained from phosphate doping and oxygendoping based on a solid solution of LiFePO₄ and LiMnPO₄. Said phosphate doping refers to moiety P being substituted by Si and at least one of As, B, Cl and S, and oxygendoping refers to moiety O being substituted by F.

Preferably, the content of the compound having the chemical constitution represented by formula I is no less than 70% by weight of the positive electrode material. More preferably, the lower limit of the content of the compound having the chemical constitution represented by formula I is preferably, but not limited to, 75%, 80%, 85%, 90% and 95% by weight of the positive electrode material.

Preferably, the positive electrode material contains a carbon coating layer.

Preferably, the content of the carbon element in the carbon coating layer is not higher than 20% by weight of the positive electrode material. More preferably, the upper limit of the content of the carbon element in the carbon coating layer is preferably, but not limited to, 15%, 10%, 5%, 4%, 3%, 2%, 1.5% and 1% by weight of the positive electrode material.

A person skilled in the art can select the mass percentage of the carbon element in the positive electrode material and the thickness of the carbon coating layer, according to practical requirements. Preferably, the thickness of the carbon coating layer in the positive electrode material is 1 nm-10 nm.

Preferably, the median particle diameter of the positive electrode material is 0.5-15 μm. More preferably, the upper limit of the range of the median particle diameter of the positive electrode material is selected from 15 μm, 12 μm, 10 μm, 9 μm, 8 μm, 7 μm and 5 μm, and the lower limit thereof is selected from 0.5 μm, 0.6 μm, 0.7 μm, 1 μm, 2 μm and 3 μm.

According to another aspect of the present application, a method for preparing a Li-ion battery positive electrode material is provided, which is characterized in at least comprising the following steps of:

a) mixing materials evenly to obtain a precursor containing Mn, Fe, Si, M, P, Li and F, a molar ratio of Mn, Fe, Si, M, P, Li to F in the precursor being:

Li:Mn:Fe:P:Si:M:F=1:x:1-x:1-a:b:c:d

wherein, M is selected from at least one of As, B, Cl and S; 0.1≦x≦0.9, 0<b≦0.15, 0<c<0.1, 0<d<0.1, a=b+c, and d<2a;

b) placing the precursor in a dynamic non-active atmosphere, sintering at a temperature of 400-900 V for 6-24 hours, and then cooling and smashing to obtain the Li-ion battery positive electrode material.

The molar ratio of Mn, Fe, Si, M, P, Li to F in the precursor in step a) is identical to that in formula I, and the values of x, a, b, c and d are selected from respective values ranges and keep the compound having the chemical constitution represented by formula I to be electrically neutral.

Preferably, the precursor in step a) further contains carbon, and a molar ratio of lithium to carbon is:

Li:C=1:0.15-2.5.

More preferably, the upper limit of the molar ratio of lithium to carbon is selected from 1:0.5 and 1:1, and the lower limit of the molar ratio is selected from 1:2.5, 1:2 and 1:1.5. Preferably, the preparing of the precursor in step a) at least comprises the following steps of:

i) mixing a Mn source, a Fe source, a Si source and a M source with water to obtain a mixture I with a percentage of water being 30%-70% by weight;

ii) adding a P source into the mixture I obtained in step i), mixing evenly, and then drying to obtain a mixture II;

iii) mixing the mixture II obtained in step ii) with a Li source, a F source and a C source evenly by using a ball-milling method, and then drying to obtain the precursor. Preferably, step iii) is adding the mixture II obtained in step ii), the Li source, the F source and the C source into a ball-milling pot, sufficiently ball-milling by using ethanol as a medium, and then drying to obtain the precursor.

A person skilled in the art may select the time for ball milling according to practical requirements to obtain a precursor with a suitable particle diameter. Preferably, the median particle diameter of the precursor is 0.3-12 μm. More preferably, the upper limit of the median particle diameter of the precursor is selected from 12 μm, 11 μm, 10 μm, 9 μm, 8 μm, 7 μm, 6 μm, and 5 μm, and the lower limit thereof is selected from 0.3 μm, 0.5 μm, 0.7 μm, 1 μm, 2 μm, 3 μm and 4 μm.

The Mn source in step i) is a compound containing Mn. Preferably, the Mn source is selected from at least one of manganese monoxide, manganous-manganic oxide, manganese dioxide, manganese carbonate, manganese acetate and manganese oxalate. The Fe source in step i) is a compound containing Fe. Preferably, the Fe source is selected from at least one of ferrous oxalate, ferrous sulfate, ferric nitrate, ferrous chloride, ferrous citrate, iron trioxide and ferroferric oxide.

The Si source in step i) is a compound containing Si. Preferably, the Si source is selected from at least one of silicon oxide, ethylorthosilicate, silicon nitride, silicon dioxide, silane crosslinked polypropylene, methyltriethoxysilane, polysiloxane, silicon monoxide, tetraethylorthosilicate, tetramethylorthosilicate, silicic acid, metasilicic acid, triethylsilicane, orthosilicic acid, disilicate, methylsilicate, tetramethylorthosilicate, and tetramethoxysilane.

The M source in step i) is a compound containing M and/or an elemental M. Preferably, the M source is selected from at least one of arsenic trioxide, sodium arsenate, calcium arsenate, sodium arsenite, boric acid, diboron trioxide, borate, borane, chloroform, ammonium chloride, ammonium sulfate and sulphur.

The P source in step ii) is a compound containing P. Preferably, the P source is selected from at least one of diammonium hydrogen phosphate, ammonium dihydrogen phosphate, triammonium phosphate, and phosphoric acid.

The Li source in step iii) is a compound containing Li, excluding lithium fluoride. Preferably, the Li source is selected from at least one of lithium oxalate, lithium carbonate, lithium nitrate, lithium sulfate, lithium acetate and lithium hydroxide.

The F source in step iii) is a compound containing F. Preferably, the F source is lithium fluoride. When the F source is lithium fluoride, Li in the precursor in step a) is from both the Li source and the F source.

The C source in step iii) is a compound containing C. Preferably, the C source is selected from at least one of glucose, saccharose, fructose, maltose, lactose, monocrystal rock sugar, starch, cellulose, citric acid, ascorbic acid, stearic acid, polyethylene glycol, polystyrene, pitch, polyvinylpyrrolidone, polyvinyl butyral, phenolic resin, and furfural resin. C in the precursor in step a) only refers to the carbon element from the C source.

Preferably, the non-active atmosphere in step b) is selected from at least one of nitrogen, argon and helium.

The dynamic non-active atmosphere in step b) is feeding a non-active gas into a sintering system. Preferably, a mass space velocity of the non-active gas passing through the precursor per unit mass during a unit time is 0.1-10 h⁻¹.

According to another aspect of the present application, provided is a Li-ion battery positive electrode, comprising any of the above positive electrode materials and/or the positive electrode material prepared by any of the above methods.

According to still another aspect of the present application, provided is a Li-ion battery with excellent cycle performance, safety performance and high-temperature storage performance.

The Li-ion battery is characterized in comprising the above positive electrode. The beneficial effects generated by the present application include at least the following:

(1) With regard to the Li-ion battery positive electrode material provided in the present application, by doping Si element with a grater atomic radius at the phosphate, dislocation of crystals in Li-insertion and Li-deinsertion states (100) is efficiently reduced at the meantime of improving the stability of the crystal lattice, and the relative volume change rate of the crystal lattice in insertion and deinsertion states of the Li ions is reduced, thus improving the cycle performance and life time of the positive electrode material.

(2) With regard to the Li-ion battery positive electrode material provided in the present application, by doping F element with a greater electronegativity at the oxygen, the phenomenon of Mn dissolving out from the positive electrode material is efficiently inhibited, the structural stability of the material is enhanced, and the problem of gas generation in high-temperature storage in the Li-ion battery caused by Mn dissolving out is solved.

(3) With regard to the Li-ion battery positive electrode material provided in the present application, through phosphate doping by As, B, Cl or S element capable of forming polyanion concerting with Si in combination with doping F with a greater electronegativity at oxygen, the polarization of the positive electrode material during charging and discharging cycles is inhibited, and the discharge voltage platform is increased, thereby increasing the energy density of the Li-ion battery.

(4) With regard to the method for preparing a positive electrode material provided in the present application, by preparing a precursor without Li in a liquid phase, then introducing a F source and a C source during the Li-providing process, and realizing doping of the phosphate and oxygen by means of sintering, the prepared modified positive electrode material has excellent cycle performance and high-temperature storage performance. The preparing method has simple process flows, and does not need expensive operation devices and can be applied to industrial productions.

(5) The Li-ion battery provided in the present application has excellent cycle performance, safety performance and high-temperature storage performance.

### DESCRIPTION OF DRAWINGS

FIG. 1 is an X-ray diffraction spectrum of a sample 1^{#} in Example One.

### SPECIFIC EMBODIMENTS

In the examples, ball-milling is carried out on a planetary ball mill of Nanda Instrument co. ltd in Nanjing.

Particle size analysis is carried out on a laser particle size distribution instrument of type MASTERSIZER2000 of Malvern Company in England.

X-ray powder diffraction phase analysis (XRD) adopts an X'Pert PRO X-ray diffractometer of the PANalytical in Netherlands, with a Cu target, a Kα radiation source (λ=0.15418 nm), a voltage of 40 KV, and a current of 40 mA.

The elemental compositions of the samples are determined by using an inductive coupling emission spectrometer (ICP-OES) of type iCAP 6300 Duo produced by Thermo Fisher.

The thickness of the carbon coating layer in the samples is observed on a transmission electron microscope (TEM) of type Tecnai G2 F20 S-TWIN of FEI company in U.S.A. The data about carbon content in the samples is carried out on a HF infrared carbon and sulfur analyzer of type HCS-140 of Dekee company in Shanghai.

The electrochemical performance test is carried out on a battery test system of type BT-2x43 of Arbin company in U.S.A.

The present application will be described in detail hereinafter with reference to examples, but the present application is not limited to those examples.

### EXAMPLE ONE

### Preparation of Samples 1^{#}-13^{#}

The specific process for preparing a sample of a positive electrode material is as below: A Mn source, a Fe source, a Si source, a M source and water were mixed to obtain a mixture I; a P source was added into the mixture I under continuous stirring until the mixture was uniform, and the mixture was dried at 80° C. for 24 hours to obtain a mixture II. The mixture 11, a Li source, lithium fluoride and a C source were added into a ball-milling pot of a ball mill to perform ball milling by using ethanol as a medium, and a precursor was obtained after ball milling and then drying at 60° C. for 4 hours. The precursor was placed in a tube furnace, and was sintered after feeding a dynamic non-active gas, which passed through the precursor at a space velocity of 0.1 h⁻¹ (the mass of the non-active gas passing through a unit mass of the precursor in unit time); after sintering was completed, the precursor was cooled to the room temperature, and the obtained solid was crashed by an airflow crash method to obtain a sample of the positive electrode material.

The relationship among the numbers of the samples of the positive electrode material, molar ratios of various elements in the precursor, water content in the mixture I, sintering temperature and time is shown in Table 1. The amounts of various materials are determined from the molar ratios of various elements in the precursor.

### COMPARATIVE EXAMPLE ONE

### Preparation of Sample D1^{#}

The differences from the preparation of sample 1^{#} in Example One were: the Si source (tetraethyl orthosilicate), the M source (arsenic trioxide), and the F source (lithium fluoride) were not added; the molar ratio of elements in the precursor was Mn:Fe:P:Li:C=0.8:0.2:1:1:0.5. The other conditions were the same as in the preparation of sample 1^{#} in Example One. The obtained sample was denoted as D1^{#}.

### COMPARATIVE EXAMPLE TWO

### Preparation of Sample D2^{#}

The differences from the preparation of sample 1^{#} in Example One were: the Si source (tetraethyl orthosilicate) and the M source (arsenic trioxide) were not added; the molar ratio of elements in the precursor was Mn:Fe:P:Li:F:C=0.8:0.2:1:0.95:0.05:0.5. The other conditions were the same as in the preparation of sample 1^{#} in Example One. The obtained sample was denoted as D2^{#}.

### COMPARATIVE EXAMPLE THREE

### Preparation of Sample D3^{#}

The differences from the preparation of sample 1^{#} in Example One were: the M source (arsenic trioxide), and the F source (lithium fluoride) were not added; the molar ratio of elements in the precursor was Mn:Fe:Si:P:Li:C=0.8:0.2:0.07:0.93:1:0.5. The other conditions were the same as in the preparation of sample 1^{#} in Example One. The obtained sample was denoted as D3^{#}.

### COMPARATIVE EXAMPLE FOUR

### Preparation of Sample D4^{#}

The differences from the preparation of sample 1^{#} in Example One were: the F source (lithium fluoride) was not added; the molar ratio of elements in the precursor was Mn:Fe:Si:As:P:Li:C=0.8:0.2:0.05:0.02:0.93:1:0.5. The other conditions were the same as in the preparation of sample 1^{#} in Example One. The obtained sample was denoted as D4^{#}.

TABLE 1

| | | | | | | | Median |
|---|---|---|---|---|---|---|---|
| | Precursor | | | | | | particle |
| | Materials: | Mass | | Median | | Sintering | diameter |
| Sam- | Mn source, Fe source, Si source, | percentage | Molar ratio of elements (the molar | particle | Non- | temper- | of the |
| ple | M source, P source, Li source, | of water | number of carbon only refers to | diameter | active | ature | sample |
| No. | F source, C source | in mixture 1 | the carbon from the C source) | (μm) | gas | time | (μm) |
| 1^{#} | manganese acetate, ferrous acetate, | 40% | Mn:Fe:Si:As:P:Li:F:C = | 2.35 | nitro- | 720° C. | 2.62 |
| | ethyl orthosilicate, arsenic trioxide, | | 0.8:0.2:0.05:0.02:0.93:1:0.05:0.5 | | gen | 9 h | |
| | phosphoric acid, lithium carbonate, | | | | | | |
| | lithium fluoride, glucose | | | | | | |
| 2^{#} | manganese acetate, ferrous acetate, | 40% | Mn:Fe:Si:As:P:Li:F:C = | 0.64 | nitro- | 720° C. | 1.02 |
| | ethyl orthosilicate, arsenic trioxide, | | 0.1:0.9:0.05:0.02:0.93:1:0.05:0.5 | | gen | 9 h | |
| | phosphoric acid, lithium carbonate, | | | | | | |
| | lithium fluoride, glucose | | | | | | |
| 3^{#} | manganese acetate, ferrous acetate, | 40% | Mn:Fe:Si:As:P:Li:F:C = | 0.35 | nitro- | 720° C. | 0.73 |
| | ethyl orthosilicate, arsenic trioxide, | | 0.4:0.6:0.05:0.02:0.93:1:0.05:0.5 | | gen | 9 h | |
| | phosphoric acid, lithium carbonate, | | | | | | |
| | lithium fluoride, glucose | | | | | | |
| 4^{#} | manganese acetate, ferrous acetate, | 40% | Mn:Fe:Si:As:P:Li:F:C = | 1.84 | nitro- | 720° C. | 3.28 |
| | ethyl orthosilicate, arsenic trioxide, | | 0.9:0.1:0.05:0.02:0.93:1:0.05:0.5 | | gen | 9 h | |
| | phosphoric acid, lithium carbonate, | | | | | | |
| | lithium fluoride, glucose | | | | | | |
| 5^{#} | manganese acetate, ferrous acetate, | 40% | Mn:Fe:Si:B:P:Li:F:C = | 7.42 | nitro- | 720° C. | 9.16 |
| | ethyl orthosilicate, boric acid, | | 0.8:0.2:0.05:0.02:0.93:1:0.05:0.5 | | gen | 9 h | |
| | phosphoric acid, lithium carbonate, | | | | | | |
| | lithium fluoride, glucose | | | | | | |
| 6^{#} | manganese acetate, ferrous acetate, | 40% | Mn:Fe:Si:S:P:Li:F:C = | 3.27 | nitro- | 720° C. | 4.37 |
| | ethyl orthosilicate, ammonium | | 0.8:0.2:0.05:0.02:0.93:1:0.05:0.5 | | gen | 9 h | |
| | sulfate, phosphoric acid, lithium | | | | | | |
| | carbonate, lithium fluoride, glucose | | | | | | |
| 7^{#} | manganese acetate, ferrous acetate, | 40% | Mn:Fe:Si:Cl:P:Li:F:C = | 0.47 | nitro- | 720° C. | 0.64 |
| | ethyl orthosilicate, ammonium | | 0.8:0.2:0.05:0.02:0.93:1:0.05:0.5 | | gen | 9 h | |
| | chloride, phosphoric acid, lithium | | | | | | |
| | carbonate, lithium fluoride, glucose | | | | | | |
| 8^{#} | manganese acetate, ferrous acetate, | 40% | Mn:Fe:Si:As:P:Li:F:C = | 11.51 | nitro- | 720° C. | 14.75 |
| | ethyl orthosilicate, arsenic trioxide, | | 0.8:0.2:0.01:0.09:0.90:1:0.01:0.5 | | gen | 9 h | |
| | phosphoric acid, lithium carbonate, | | | | | | |
| | lithium fluoride, glucose | | | | | | |
| 9^{#} | manganese acetate, ferrous acetate, | 40% | Mn:Fe:Si:As:P:Li:F:C = | 3.46 | nitro- | 720° C. | 4.02 |
| | ethyl orthosilicate, arsenic trioxide, | | 0.8:0.2:0.10:0.01:0.89:1:0.07:0.5 | | gen | 9 h | |
| | phosphoric acid, lithium carbonate, | | | | | | |
| | lithium fluoride, glucose | | | | | | |
| 10^{#} | manganese acetate, ferrous acetate, | 40% | Mn:Fe:Si:As:P:Li:F:C = | 6.68 | nitro- | 720° C. | 6.95 |
| | ethyl orthosilicate, arsenic trioxide, | | 0.8:0.2:0.15:0.05:0.80:1:0.09:0.5 | | gen | 9 h | |
| | phosphoric acid, lithium carbonate, | | | | | | |
| | lithium fluoride, glucose | | | | | | |
| 11^{#} | manganese oxalate, ferrous oxalate, | 30% | Mn:Fe:Si:As:P:Li:F:C = | 1.17 | argon | 450° C. | 3.55 |
| | methyl silicate, sodium arsenate, | | 0.8:0.2:0.05:0.02:0.93:1:0.05:1.7 | | | 24 h | |
| | ammonium dihydrogen phosphate, | | | | | | |
| | lithium hydroxide, lithium fluoride, | | | | | | |
| | sucrose | | | | | | |
| 12^{#} | manganese carbonate, ferric nitrate, | 70% | Mn:Fe:Si:As:P:Li:F:C = | 2.81 | nitro- | 900° C. | 5.21 |
| | tetramethyl orthosilicate, calcium | | 0.8:0.2:0.05:0.02:0.93:1:0.05:1.0 | | gen | 6 h | |
| | arsenate, diammonium hydrogen | | | | | | |
| | phosphate, lithium acetate, lithium | | | | | | |
| | fluoride, polyethylene glycol | | | | | | |
| 13^{#} | manganese oxalate, ferrous sulfate, | 50% | Mn:Fe:Si:As:P:Li:F:C = | 9.32 | nitro- | 550° C. | 11.75 |
| | tetraethyl orthosilicate, sodium | | 0.8:0.2:0.05:0.02:0.93:1:0.05:2.4 | | gen | 16 h | |
| | arsenite, ammonium dihydrogen | | | | | | |
| | phosphate, lithium hydroxide, | | | | | | |
| | lithium fluoride, | | | | | | |
| | polyvinylpyrrolidone | | | | | | |
| D1^{#} | manganese acetate, ferrous acetate, | 30% | Mn:Fe:P:Li:C = | 7.45 | nitro- | 720° C. | 8.82 |
| | phosphoric acid, lithium carbonate, | | 0.8:0.2:1:1:0.5 | | gen | 9 h | |
| | glucose (without Si source, M | | | | | | |
| | source or F source) | | | | | | |
| D2^{#} | manganese acetate, ferrous acetate, | 30% | Mn:Fe:P:Li:F:C = | 6.93 | nitro- | 720° C. | 8.59 |
| | phosphoric acid, lithium carbonate, | | 0.8:0.2:1:1:0.05:0.5 | | gen | 9 h | |
| | lithium fluoride, glucose (without Si | | | | | | |
| | source or M source) | | | | | | |
| D3^{#} | manganese acetate, ferrous acetate, | 30% | Mn:Fe:Si:P:Li:C = | 8.14 | nitro- | 720° C. | 9.35 |
| | ethyl orthosilicate, phosphoric acid, | | 0.8:0.2:0.07:0.93:1:0.5 | | gen | 9 h | |
| | lithium carbonate, glucose (without | | | | | | |
| | M source or F source) | | | | | | |
| D4^{#} | manganese acetate, ferrous acetate, | 30% | Mn:Fe:Si:As:P:Li:C = | 4.77 | nitro- | 720° C. | 5.79 |
| | ethyl orthosilicate, arsenic trioxide, | | 0.8:0.2:0.05:0.02:0.93:1:0.5 | | gen | 9 h | |
| | phosphoric acid, lithium carbonate, | | | | | | |
| | glucose (without F source) | | | | | | |

### EXAMPLE TWO

### Test on Particle Size of the Samples

The particle sizes of samples 1^{#}-13^{#} obtained in Example One and comparative samples D1^{#}-D4^{#} obtained in Comparative Examples One-Four as well as the precursor were tested. The results are shown in Table 1.

### EXAMPLE THREE

### Elemental Composition and Structure Test of Samples

The composition of the element, the atomic number of which is greater than 9, in the samples 1^{#}-13^{#} and comparative samples D1^{#}-D4^{#} was determined by using ICP-OES. The results are shown in Table 2.

The content of carbon in the above samples 1^{#}-13^{#} and comparative samples D1^{#}-D4^{#} was analyzed by a HF infrared carbon and sulfur analyzer of type HCS-140 available from Dekee in Shanghai. The results are shown in Table 2.

Samples 1^{#}-13^{#} obtained in Example One and comparative samples D1^{#}-D4^{#} obtained in Comparative Examples One-Four were observed by using a TEM, and the range of the thicknesses of the carbon coating layers were recorded. The results are shown in Table 2.

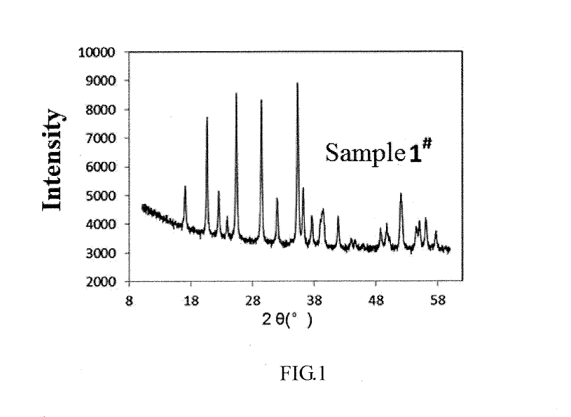

Samples 1¹⁹⁰ -13^{#} and D1^{#}-D4^{#} were subjected to XRD analysis. The results show that they all have the same crystal structure as the olivine-type lithium iron phosphate of an orthorhombic crystal system. The XRD spectrogram of the typical representative sample 1^{#} is as shown in FIG. 1, and the XRD spectrograms of other samples are all similar to that in FIG. 1, i.e., the positions of diffraction peaks are the same. Depending upon the changes of synthesis conditions, the relative peak intensity of the diffraction peak varies within a range of ±10%.

TABLE 2

| | | | Thickness |
|---|---|---|---|
| | | Mass | of Carbon |
| Sample | | Percentage | Coating |
| No. | Elemental Composition of Samples | of Carbon | Layer |
| 1^{#} | LiMn_{0.8}Fe_{0.2}P_{0.93}Si_{0.05}As_{0.02}O_{3.95}F_{0.05} | 2.13% | 1-3 nm |
| 2^{#} | LiMn_{0.1}Fe_{0.9}P_{0.93}Si_{0.05}As_{0.02}O_{3.95}F_{0.05} | 1.74% | 1-3 nm |
| 3^{#} | LiMn_{0.4}Fe_{0.6}P_{0.93}Si_{0.05}As_{0.02}O_{3.95}F_{0.05} | 2.45% | 3-5 nm |
| 4^{#} | LiMn_{0.9}Fe_{0.1}P_{0.93}Si_{0.05}As_{0.02}O_{3.95}F_{0.05} | 1.38% | 2-3 nm |
| 5^{#} | LiMn_{0.8}Fe_{0.2}P_{0.93}Si_{0.05}B_{0.02}O_{3.95}F_{0.05} | 1.52% | 1-3 nm |
| 6^{#} | LiMn_{0.8}Fe_{0.2}P_{0.93}Si_{0.05}S_{0.02}O_{3.95}F_{0.05} | 4.34% | 3-4 nm |
| 7^{#} | LiMn_{0.8}Fe_{0.2}P_{0.93}Si_{0.05}Cl_{0.02}O_{3.95}F_{0.05} | 2.49% | 2-4 nm |
| 8^{#} | LiMn_{0.8}Fe_{0.2}P_{0.90}Si_{0.01}As_{0.09}O_{3.99}F_{0.01} | 3.11% | 3-5 nm |
| 9^{#} | LiMn_{0.8}Fe_{0.2}P_{0.89}Si_{0.10}As_{0.01}O_{3.93}F_{0.07} | 1.82% | 1-3 nm |
| 10^{#} | LiMn_{0.8}Fe_{0.2}P_{0.80}Si_{0.15}As_{0.05}O_{3.91}F_{0.09} | 3.37% | 2-5 nm |
| 11^{#} | LiMn_{0.8}Fe_{0.2}P_{0.93}Si_{0.05}As_{0.02}O_{3.95}F_{0.05} | 14.10% | 6-8 nm |
| 12^{#} | LiMn_{0.8}Fe_{0.2}P_{0.93}Si_{0.05}As_{0.02}O_{3.95}F_{0.05} | 9.75% | 4-7 nm |
| 13^{#} | LiMn_{0.8}Fe_{0.2}P_{0.93}Si_{0.05}As_{0.02}O_{3.95}F_{0.05} | 19.94% | 7-10 nm |
| D1^{#} | LiMn_{0.8}Fe_{0.2}PO₄ | 3.15% | 3-4 nm |
| D2^{#} | LiMn_{0.8}Fe_{0.2}PO_{3.95}F_{0.05} | 2.04% | 1-3 nm |
| D3^{#} | LiMn_{0.8}Fe_{0.2}P_{0.93}Si_{0.07}O₄ | 1.89% | 2-3 nm |
| D4^{#} | LiMn_{0.8}Fe_{0.2}P_{0.93}Si_{0.05}As_{0.02}O₄ | 2.16% | 1-3 nm |

### EXAMPLE FOUR

### Preparation of Li-ion Batteries C1^{#}-C13^{#}, CD1^{#}-CD4^{#}

Preparation of Positive Electrode

The samples 1^{#}-13^{#} obtained in Example One and comparative samples D1^{#}-D4^{#} obtained in Comparative Examples One-Four were used as a positive active material respectively. The positive active material, a binder PVDF (polyvinylidene fluoride) and a conductive carbon black were mixed, and stirred at a high speed to disperse uniformly, thereby preparing a mixture containing the positive active material. In the mixture, the solid component includes 94 wt % of the positive active material, 4 wt % of PVDF and 2 wt % of conductive carbon black. The mixture was formulated into a slurry of the positive active material by using NMP (N-Methylpyrrolidone) as a solvent, and the content of solid in the slurry was 75 wt %. The slurry was evenly coated on both surfaces of an aluminum foil, which was then dried and compacted by a roller press, obtaining positive electrodes containing samples 1^{#}-13^{#} and comparative samples D1^{#}-D4^{#} as the positive active materials respectively, and denoted as positive electrodes P1^{#}-P13^{#}, and positive electrodes PD1^{#}-PD4^{#} respectively.

Preparation of Negative Electrode

An active material (artificial graphite), a binder emulsion, a thickening agent (sodium carboxymethyl cellulose) and a conductive agent (conductive carbon black) were mixed, and stirred at a high speed to disperse evenly, thus obtaining a mixture containing a negative active material. In the mixture, the solid component includes 96 wt % of artificial graphite, 2 wt % of sodium carboxymethyl cellulose, 1 wt % of conductive carbon black and 1 wt % of the binder. The mixture was formulated into a slurry of the negative active material by using water as a solvent, and the content of solid in the slurry was 50 wt %.

The slurry was evenly coated on both surfaces of a copper foil, which was then dried and compacted by a roller press, obtaining a negative electrode, which was denoted as N1^{#}.

The coating weight ratio of the positive electrode to the negative electrode was controlled such that the negative capacity/positive capacity=1.20.

Preparation of Li-Ion Battery

Conductive tabs were welded onto the positive electrode and the negative electrode, a polypropylene/polyethylene composite separator of 16 μm (PP/PE composite separator) was used, and the positive electrode, the separator and the negative electrode were stacked in order so that the separator is placed between the positive and negative to play a separation function, and then were wound to form a bare cell, and then was encapsulated with an Al-plastic film. 1M of lithium hexafluorophosphate electrolyte was used as the electrolyte, and the solvent was a mixed solvent of ethylene carbonate (EC) and dimethyl carbonate (DMC)=3:7 (volume ratio). The battery was subjected to formation and aging after encapsulation to obtain a Li-ion battery.

The Li-ion batteries prepared by using P1^{#}-P13^{#}, PD1^{#}-PD4 as the positive electrode respectively and N1^{#} as the negative electrode were denoted as Li-ion batteries C1^{#}-C13^{#} and Li-ion batteries CD1^{#}-CD4^{#} respectively.

### EXAMPLE FIVE

### Test on Discharge Capacity of Li-Ion Batteries

The first discharge capacities of Li-ion batteries C1^{#}-C13^{#} and Li-ion batteries CD1^{#}-CD4^{#} were tested respectively. The specific test method was as below:

Each battery was firstly subjected to formation, and was firstly charged for 20 hours at 45 V with a constant current of 0.02 C; then was charged to 4.2V at room temperature with a constant current of 0.5 C, and then was charged to 0.05 C at a constant voltage. After standing for 5 min, the battery was discharged to 2.8 V with 0.5 C. The discharge capacity was recorded.

The first discharge of each battery is as shown in Table 3.

### EXAMPLE SIX

### Test on Storage Performance of Li-Ion Battery at 45 V

The storage performances of Li-ion batteries C1^{#}-C13^{#} and Li-ion batteries CD1^{#}-CD4^{#} at 45° C. were tested respectively. The specific test method was as below: Each battery was charged to 4.2V at room temperature with a constant current of 1 C, and then was charged to 0.05V with a constant voltage, and after one hour's standing, its thickness, voltage and internal resistance were tested and then the battery was placed in a thermotank of 45° C.; after standing of 30 days, its thickness, voltage and internal resistance were tested at 45° C.; then the battery was cooled to room temperature, and charged to 4.2V at a constant current of 0.5 C, and then charged to 0.05V with a constant voltage, and after standing for 5 min, the battery was discharged to 2.5V at 0.5 C, and the discharge capacity was recorded. A thickness swelling rate and a capacity retention ratio were calculated according to the results of the test.

thickness swelling rate=(thickness after storage−thickness before storage)/thickness before storage×100%.

capacity retention ratio=discharge capacity after storage/discharge capacity before storage×100%.

The thickness swelling rate and capacity retention ratio of each battery after storage at 45° C. for 30 days were as shown in Table 3.

### EXAMPLE SEVEN

### Test on Storage Performance of Li-Ion Battery at 60° C.

The storage performances of Li-ion batteries C1^{#}-C13^{#} and Li-ion batteries CD1^{#}-CD4^{#} at 60° C. were tested respectively. The specific test method was as below: Each battery was charged to 4.2V at room temperature with a constant current of 1C, and then was charged to 0.05V with a constant voltage, and after one hour's standing, its thickness, voltage and internal resistance were tested and then the battery was placed in a thermotank of 60° C.; after standing of 30 days, its thickness, voltage and internal resistance were tested at 60° C.; then the battery was cooled to room temperature, and charged to 4.2V at a constant current of 0.5 C, and then charged to 0.05V with a constant voltage, and after standing for 5 min, the battery was discharged to 2.5V at 0.5 C, and the discharge capacity was recorded. A thickness swelling rate and a capacity retention ratio were calculated according to the results of the test.

thickness swelling rate=(thickness after storage−thickness before storage)/thickness before storage×100%.

capacity retention ratio=discharge capacity after storage/discharge capacity before storage×100%.

The thickness swelling rate and capacity retention ratio of each battery after storage at 60° C. for 30 days were as shown in Table 3.

### EXAMPLE EIGHT

### Test on Cycle Performance of Li-Ion Battery at 25° C.

The cycle performances of Li-ion batteries C1^{#}-C13^{#} and Li-ion batteries CD1^{#}-CD4^{#} at 25° C. were tested respectively. The specific test method was as below:

Each battery was charged to 4.2V at 25° C. with a constant current of 1 C, and then was charged to 0.05V with a constant voltage, and then stood still for 30 min; then the battery was discharged to 2.8V with a constant current of IC, and stood still for 30 min. Cycle was performed for 500 times. The capacity retention ratio was calculated according to the results of the test.

capacity retention ratio=discharge capacity of the 500^{th} cycle/discharge capacity of the first cycle×100%.

The capacity retention rate after 500 cycles of each battery at 25° C. was as shown in Table 3.

### EXAMPLE NINE

### Test on Cycle Performance of Li-Ion Battery at 45° C.

The cycle performances of Li-ion batteries C1^{#}-C13^{#} and Li-ion batteries CD1^{#}-CD4^{#} at 45° C. were tested respectively. The specific test method was as below:

Each battery was charged to 4.2V at 45° C. with a constant current of 1 C, and then was charged to 0.05V with a constant voltage, and then stood still for 30 min; then the battery was discharged to 2.8V with a constant current of 1 C, and stood still for 30 min. Cycle was performed for 500 times. The capacity retention ratio was calculated according to the results of the test.

capacity retention ratio=discharge capacity of the 500^{th} cycle/discharge capacity of the first cycle×100%.

The capacity retention rate after 500 cycles of each battery at 45° C. was as shown in Table 3.

TABLE 3

| | | | | | | Capacity | Capacity |
|---|---|---|---|---|---|---|---|
| | First | 45° C./30 d storage | | 60° C./30 d storage | | Retention | Retention |
| | Discharge | Thickness | | Thickness | | Rate after | Rate after |
| Li-ion | capacity | Swelling | Capacity | Swelling | Capacity | 500 cycles | 500 cycles |
| Battery | per gram | Percentage | Retention | Percentage | Retention | at 25° C. | at 45° C. |
| No. | (mAh/g) | (%) | Rate (%) | (%) | Rate (%) | (%) | (%) |
| C1^{#} | 145.1 | 16.8 | 96.1 | 36.4 | 90.7 | 96.0 | 91.3 |
| C2^{#} | 151.4 | 23.7 | 97.2 | 43.8 | 91.5 | 96.5 | 92.7 |
| C3^{#} | 146.6 | 19.4 | 94.4 | 39.1 | 89.0 | 94.7 | 90.0 |
| C4^{#} | 141.7 | 31.5 | 93.8 | 51.2 | 88.4 | 93.8 | 89.2 |
| C5^{#} | 144.7 | 21.3 | 95.2 | 41.9 | 89.3 | 94.2 | 89.7 |
| C6^{#} | 143.8 | 24.5 | 94.7 | 44.4 | 89.8 | 95.4 | 91.1 |
| C7^{#} | 140.0 | 33.4 | 91.4 | 53.5 | 86.3 | 91.7 | 87.4 |
| C8^{#} | 141.3 | 37.4 | 93.9 | 57.1 | 88.5 | 93.9 | 89.4 |
| C9^{#} | 139.7 | 27.9 | 94.2 | 47.8 | 88.8 | 94.2 | 89.0 |
| C10^{#} | 138.9 | 45.5 | 93.1 | 65.0 | 87.7 | 93.1 | 88.1 |
| C11^{#} | 139.5 | 55.2 | 91.4 | 76.4 | 82.7 | 94.1 | 89.3 |
| C12^{#} | 140.6 | 33.9 | 92.3 | 54.6 | 82.2 | 91.6 | 87.3 |
| C13^{#} | 138.7 | 52.2 | 90.8 | 79.9 | 86.4 | 95.8 | 91.5 |
| CD1^{#} | 135.4 | 128.5 | 87.1 | 152.2 | 78.5 | 83.9 | 78.2 |
| CD2^{#} | 137.4 | 117.7 | 90.1 | 142.7 | 80.7 | 86.1 | 81.3 |
| CD3^{#} | 136.8 | 120.3 | 88.5 | 137.9 | 78.8 | 85.3 | 78.3 |
| CD4^{#} | 136.9 | 111.2 | 89.4 | 135.4 | 79.3 | 84.7 | 75.4 |

It can be seen from the data in Table 3 that:

By comparing the data corresponding to Li-ion batteries C1^{#}, C2^{#}, C3^{#}, C4^{#}, DC1^{#}, DC2^{#}, DC3^{#} and DC4^{#}, it can be seen that the positive electrode materials prepared by performing concerted doping at P using Si and As and meanwhile performing doping at O using F have apparently improved storage performance at 45° C./30 days and at 60° C./30 days, notable decrease in thickness swelling rate and remarkable increase in capacity retention rate, as compared with the materials without doping treatment and materials with only doping at P or only doping at O. It suggests that the high-temperature gas generation phenomenon of the material is efficiently inhibited after concerted doping treatment. Meanwhile, the cycle performances at 25° C. and below 45° C. are also apparently improved, and the discharge capacity per gram of the materials are also slightly increased; the prepared materials with different Mn/Fe ratios all represent excellent storage performance and cycle performance.

By comparing the data corresponding to Li-ion batteries C1^{#}, C5^{#}, C6^{#}, C7^{#}and DC1^{#}, it can be seen that the crystal structure of the material can be stabilized by performing concerted doping at P using different elements (any one of As, B, S and Cl) with Si in combination with doping at O using F, and Mn dissolving out at a high temperature or during cycle process is suppressed, and the high-temperature storage performance, the room-temperature cycle performance and the high-temperature cycle performance of the batteries are remarkably improved.

By comparing the data corresponding to Li-ion batteries C1^{#}, C8^{#}, C9^{#}, C10^{#}, DC1^{#}, DC2^{#}, DC3^{#} and DC4^{#}, it can be seen that the storage performance and cycle performance of the positive electrode material can be notably improved by performing composite doping at P using different amounts of Si and As in combination with concerted doping at O using different amounts of F, but the first discharge capacity per gram has slight loss with the increase of the doping amount.

By comparing the data corresponding to Li-ion batteries C1^{#}, C11^{#}, C12^{#} and C13^{#}, it can be seen that the material prepared by using different Mn sources, Fe sources, Si sources, M sources, phosphate radical sources, Li sources and C sources all have excellent electrochemical performance. The structures of the surface coating carbon layers of the prepared materials are slightly different under the protection of different non-active atmospheres, which may cause slight fluctuation of the capacity per gram. When the content of carbon exceeds 10%, the capacity per gram and storage performance of the materials both decrease with the increase of the carbon content. Meanwhile with the changes of the sintering temperature and sintering time, the Li-ion batteries according to the technical solution of the present application still represent excellent storage performance and discharge capacity per gram.

According to the above disclosure of the description, a person skilled in the art may also make appropriate amendments and modifications to the above embodiments. Therefore, the present application is not limited to the above disclosure and the described specific embodiments. Any amendments or modifications made to the present application shall also fall into the protection scope of the claims of the present application.

1. A Li-ion battery positive electrode material, comprising a compound having a chemical constitution represented by formula I:
LiMnxFe1-xP1-aSibMcO4-dFd Formula I
in which, M is selected from at least one of As, B, Cl and S; 0.1≦x≦0.9, 0<b≦0.15, 0<c<0.1, 0<d<0.1, a=b+c, and d<2a.

2. The positive electrode material according to claim 1, wherein, the compound having a chemical constitution represented by formula I has an olivine-type crystal structure of an orthorhombic crystal system.

3. The positive electrode material according to claim 1, wherein, the positive electrode material contains a carbon coating layer.

4. The positive electrode material according to claim 3, wherein, a content of carbon in the carbon coating layer is not higher than 20% by weight of the positive electrode material.

5. The positive electrode material according to claim 1, wherein, a median particle diameter of the positive electrode material is 0.5-15 μm.

6. A method for preparing a Li-ion battery positive electrode material, at least comprising the following steps of:
a) mixing materials evenly to obtain a precursor containing Mn, Fe, Si, M, P, Li and F, a molar ratio of Mn, Fe, Si, M, P, Li to F in the precursor being:
Li: Mn:Fe:P:Si:M:F=1:x:1-x:1-a:b:c:d
wherein, M is selected from at least one of As, B, Cl and S; 0.1≦x≦0.9, 0<b≦0.15, 0<c<0.1, 0<d<0.1, a=b+c, and d<2a;
b) placing the precursor in a dynamic non-active atmosphere, sintering at a temperature of 400-900° C. for 6-24 hours, and then cooling and smashing to obtain the Li-ion battery positive electrode material.

7. The method according to claim 6, wherein, the precursor in step a) contains carbon, and a molar ratio of lithium to carbon is:
Li:C=1:0.15-2.5.

8. The method according to claim 6, wherein, the preparing of the precursor in step a) at least comprises the following steps of:
i) mixing a Mn source, a Fe source, a Si source and a M source with water to obtain a mixture I with a percentage of water being 30%-70% by weight;
ii) adding a P source into the mixture I obtained in step i), stirring evenly, and then drying to obtain a mixture II;
iii) mixing the mixture II obtained in step ii) with a Li source, a F source and a C source evenly by using a ball-milling method, and then drying to obtain the precursor.

9. A Li-ion battery positive electrode, comprising the positive electrode material of claim 1 and the positive electrode material prepared according to the method of
a) mixing materials evenly to obtain a precursor containing Mn, Fe, Si, M, P, Li and F, a molar ratio of Mn, Fe, Si, M, P, Li to F in the precursor being:
Li:Mn:Fe:P:Si:M:F=1:x:1-x:1-a:b:c:d
wherein, M is selected from at least one of As, B, Cl and S; 0.1≦x≦0.9, 0<b≦0.15, 0<c<0.1, 0<d<0.1, a=b+c, and d<2a;
b) placing the precursor in a dynamic non-active atmosphere, sintering at a temperature of 400-900° C. for 6-24 hours, and then cooling and smashing to obtain the Li-ion battery positive electrode material.

10. A Li-ion battery, comprising the Li-ion battery positive electrode of claim 9.

11. A Li-ion battery positive electrode, comprising the positive electrode material prepared according to the method of claim 6.

12. A Li-ion battery, comprising the Li-ion battery positive electrode of claim 11.
